(19) United States
(12) Patent Application Publication
(10) Pub. No.: US 2014/0038307 A1
(43) Pub. Date: Feb. 6, 2014

(54) REAGENT VESSEL INSERT, REAGENT VESSELS, METHOD FOR THE CENTRIFUGING OF AT LEAST ONE MATERIAL AND METHOD FOR THE PRESSURE TREATMENT OF AT LEAST ONE MATERIAL

(71) Applicant: Robert Bosch GmbH, Stuttgart (DE)

(72) Inventors: Martina Daub, Weissach (DE); Guenter Roth, Freiburg (DE); Ame Kloke, Freiburg (DE); Juergen Steigert, Stuttgart (DE); Felix von Stetten, Freiburg-Tiengen (DE); Nils Paust, Freiburg (DE)

(73) Assignee: Robert Bosch GmbH, Stuttgart (DE)

(21) Appl. No.: 13/956,662

(22) Filed: Aug. 1, 2013

(30) Foreign Application Priority Data
Aug. 3, 2012 (DE) 10 2012 213 757.2

(51) Int. Cl. B01L 3/00; B04B 7/12

(52) U.S. Cl. CPC B01L 3/52; B04B 7/12
USPC 436/177; 422/548; 422/560; 436/174

(57) ABSTRACT

A reagent vessel insert for a reagent vessel for a centrifuge and/or a pressure varying device includes an insert housing formed such that the reagent vessel insert is insertable in a reagent vessel for a centrifuge and/or for a pressure varying device. The reagent vessel insert also includes at least one agitating element arranged in at least one interior volume such that a place and/or position of the at least one agitating element is changeable with respect to the insert housing. The reagent vessel insert is configured such that at least one material filled into the at least one interior volume is agitatable and such that, during an adjustment, at least one subunit of the at least one agitating element contacting at least one holding structure, by which the at least one agitating element is held in at least one semi-stable place and/or at least one semi-stable position.

This application claims priority under 35 U.S.C. §119 to patent application no. DE 10 2012 213 757.2, filed on Aug. 3, 2012 in Germany, the disclosure of which is incorporated herein by reference in its entirety.

### BACKGROUND

The disclosure relates to a reagent vessel insert for a reagent vessel for a centrifuge and/or a pressure varying device. Similarly, the disclosure relates to reagent vessels for a centrifuge and/or to a pressure varying device. Furthermore, the disclosure relates to a method for the centrifuging of at least one material and to a method for the pressure treatment of at least one material.

DE 10 2010 003 224 A1 describes a mixer for inserting into a rotor of a centrifuge. The mixer comprises a mixing trough and an obstacle device, which is formed such that a spacing between at least one wall section of the mixing trough and the obstacle device is variable. By means of varying the spacing, it is intended that a liquid located in the mixing trough can be forced through at least one through-opening in the obstacle device to mix the liquid.

### SUMMARY

The disclosure provides a reagent vessel insert for a reagent vessel for a centrifuge and/or a pressure varying device with the features described below, a reagent vessel for a centrifuge and/or a pressure varying device with the features described below, a reagent vessel for a centrifuge and/or a pressure varying device with the features described below, a method for the centrifuging of at least one material with the features described below and a method for the pressure treatment of at least one material with the features described below.

The present disclosure allows more efficient mixing of at least one material during a centrifuging operation, application of a negative pressure and/or application of a positive pressure. As specified more precisely below, by means of the at least one obstacle structure, higher levels of energy can be introduced into the at least one material to be mixed. The increase in the energy exerted on the at least one material to be mixed leads to an increase in the mixing efficiency during the mixing of the at least one material. Consequently, even highly viscous liquids, powders and/or readily agglomerating clusters of particles can be successfully mixed by means of the present disclosure.

The devices and methods that can be realized by means of the present disclosure are compatible with centrifugal processing and/or pressure-driven processing, in particular by using at least one turret component/turret. The present disclosure can be implemented by using a number of turret/turret components which are stacked axially one on top of the other and comprise cavities for performing fluidic unit operations. Switching of the cavities in relation to one another can be performed by means of at least one ballpoint pen mechanism or a ratchet mechanism. In this way, the turrets can be positioned in relation to one another axially and also azimuthally. The present disclosure can consequently be integrated in an advantageous technology for the switching of chemical reactions and/or of biochemical/molecular biological processes.

In the case of a mixing method performed without the use of a holding structure, a speed of an agitating element that can be adjusted in a mixing chamber by means of a force exerted on it is generally dependent on a derivative of the respective force. For example, when using a centrifugal force field for adjusting the agitating element, the speed of the deflection of the agitating element is dependent on the change in acceleration of the centrifugal force field. Therefore, in the case of a mixing method performed without a holding structure, only low levels of energy can be exerted on the at least one material to be mixed by means of the at least one agitating element. By contrast, by means of the present disclosure, far higher levels of energy can be exerted on the at least one material to be mixed by means of the at least one agitating element. This ensures reliable mixing of the at least one material to be mixed.

The mixing of different liquids is often a basic precondition for carrying out chemical methods and/or biochemical/molecular biological processes. The improved mixing efficiency that can be achieved by means of the present disclosure can consequently ensure a more advantageous/faster/more thorough execution of chemical reactions and/or biochemical/molecular biological processes.

In an advantageous embodiment, the at least one agitating element is adjustable by means of a centrifugal force which can be brought about during operation of the centrifuge in which the reagent vessel is inserted and/or a compressive force which can be brought about during operation of the pressure varying device in which the reagent vessel is inserted. It is therefore possible to use forces that can easily be applied for adjusting the at least one agitating element by means of which the at least one material is agitated.

Furthermore, it is possible that the at least one agitating element can be held in the at least one semi-stable place and/or the at least one semi-stable position until the centrifugal force which can be brought about and/or the compressive force which can be brought about exceeds a threshold value fixed by means of the form of the at least one contacted holding structure. When the threshold value is exceeded by the centrifugal force which can be brought about and/or the compressive force which can be brought about, preferably at least the at least one subunit of the at least one agitating element can be adjusted further along at least one subsection of the adjusting path. Since the threshold value can consequently be easily fixed by means of the form of the at least one assigned holding structure, the energy exerted on the at least one material to be mixed during the further adjustment of the at least one agitating element can also be easily fixed and provided by way of the centrifugal force and/or the compressive force.

In particular, it is possible that, when the threshold value is exceeded by means of the centrifugal force which can be brought about and/or by means of the compressive force which can be brought about, the at least one agitating element can be thrown out from the at least one semi-stable place and/or from the at least one semi-stable position. During the throwing out of the at least one agitating element, a comparatively great amount of kinetic energy is transferred to the at least one material to be mixed. In particular, in this way even liquids with a high viscosity, powders and/or mixtures with readily agglomerating particles can be efficiently/reliably mixed.

In an advantageous development, at least one elastic restoring element is arranged on the at least one agitating element in such a way that at least the at least one subunit of the at least one agitating element can be adjusted from a starting position into a maximum deflecting position by means of a centrifugal force which can be brought about and/or a compressive force which can be brought about that is greater that a restoring force of the respective at least one restoring element, and can be adjusted back into the starting position when there is a centrifugal force which can be brought about and/or a compressive force which can be brought about that is less than the restoring force. In particular, in this case the at least one holding structure can be used repeatedly for exerting a comparatively great kinetic energy on the at least one material to be mixed. Consequently, the at least one material to be mixed can be reliably mixed in a low-cost way by merely varying the centrifugal force/compressive force.

For example, the at least one holding structure may protrude from at least one inner wall of the at least one interior volume. The at least one holding structure may consequently be formed at the same time during the production of the inner wall in a low-cost way.

In an advantageous embodiment, the at least one holding structure is at least partially formed from an elastic material. This ensures frequent use of the at least one holding structure, damage thereto being reliably prevented. The at least one holding structure may, however, also be formed from an inelastic material.

In a further advantageous form, the at least one agitating element has rake structures, screen structures, finger structures and/or grid structures. In this case, on the at least one agitating element there are respectively formed a multiplicity of openings/clearances, through which the at least one material to be mixed can be forced by means of the energy that can be introduced. This ensures a high mixing efficiency.

In a further advantageous embodiment, the at least one agitating element is fixedly attached at its first end to the reagent vessel insert, while a second end of the respective agitating element is adjustable with respect to the first end of the same agitating element by bending of at least one intermediate subsection of the same agitating element. Consequently, the at least one agitating element can be configured in a low-cost way even for exerting a restoring force on the second end that is used as an adjustable subunit. By means of the variation of the centrifugal force/compressive force already described above, consequently the at least one second end can be repeatedly adjusted along the adjusting path. In this way, a comparatively great kinetic energy can be transferred to the at least one material to be mixed.

In a development, an additional mass may be attached to the second end of the at least one agitating element. Since the flow energy brought about in the at least one material to be mixed is proportional to the accelerated mass, the flow rate can consequently be increased significantly, which on account of the internal friction of the at least one material to be mixed leads to a chaotic flow behavior of this material. In this way, the mixing efficiency can be additionally increased.

For example, the reagent vessel insert may be formed as a turret component. The present disclosure can consequently be advantageously integrated in the use of turret component/turrets for switching liquids in relation to one another. However, the forms that the reagent vessel insert can take are not limited to such a turret component.

The advantages described above are also ensured in the case of a reagent vessel for a centrifuge and/or a pressure varying device with at least one such reagent vessel insert.

Similarly, the advantages described can be realized by means of a corresponding reagent vessel for a centrifuge and/or a pressure varying device. The advantages are ensured in the case of a reagent vessel with an outer wall which is formed such that the reagent vessel can be inserted in a centrifuge and/or in a pressure varying device, and at least one agitating element which is arranged in at least one interior volume formed in the reagent vessel such that a place and/or a position of the at least one agitating element with respect to the outer wall can be changed, at least one subunit of the at least one agitating element being adjustable along an adjusting path such that at least one material that can be filled or has been filled into the at least one interior volume can be agitated, and, during an adjustment along the adjusting path, at least the at least one subunit of the at least one agitating element contacting at least one holding structure, by means of which the at least one agitating element can be held in at least one semi-stable place and/or at least one semi-stable position with respect to the outer wall. The reagent vessel can be developed further in a way corresponding to the embodiments and/or further developments described above.

Furthermore, the advantages can also be brought about by performing the method for the centrifuging of at least one material or by performing the method for the pressure treatment of at least one material. Each of the methods can be developed further in a way corresponding to the embodiments/further developments described above.

### BRIEF DESCRIPTION OF THE DRAWINGS

Further features and advantages of the present disclosure are explained below on the basis of the figures, in which:

FIG. 1 shows a schematic partial representation of a first embodiment of the reagent vessel insert;

FIG. 2 shows a schematic partial representation of a second embodiment of the reagent vessel insert;

FIGS. 3a-3c show schematic partial representations of a third embodiment of the reagent vessel insert;

FIGS. 4a-4d show schematic partial representations of a fourth embodiment of the reagent vessel insert;

FIGS. 5a and 5b show schematic partial representations of a fifth embodiment of the reagent vessel insert;

FIG. 6 shows a schematic representation of an embodiment of the reagent vessel;

FIG. 7 shows a flow diagram for presenting an embodiment of the method for the centrifuging of at least one material; and

FIG. 8 shows a flow diagram for explaining an embodiment of the method for the pressure treatment of at least one material.

### DETAILED DESCRIPTION

The figures explained below respectively show reagent vessel inserts 10 for a reagent vessel 36 for a centrifuge and/or a pressure device and/or a reagent vessel 36 for a centrifuge and/or a pressure device. The respective reagent vessel 36 for a centrifuge and/or a pressure device has an outer wall 36a/outer form (not specified any more precisely), which is formed such that the reagent vessel 36 can be inserted into a centrifuge and/or a pressure varying device. The reagent vessel 36 is preferably formed such that a reliable hold/fit of the reagent vessel 36 in the operated centrifuge and/or in the operated pressure varying device is ensured. A reagent vessel 36 for a centrifuge and/or a pressure varying device may consequently be understood as meaning a reagent vessel 36 that is well suited on the basis of its outer form for operation of the centrifuge at a comparatively great rotational speed and/or for application of a positive and/or negative pressure deviating greatly from atmospheric pressure by means of the pressure varying device.

The reagent vessel 36 may be understood as meaning for example a (standard) test tube. Other exemplary embodiments are centrifuge tubes (for example 15 ml centrifuge tubes and 50 ml centrifuge tubes), 0.5 ml Eppendorf tubes, 1.5 ml Eppendorf tubes, 2 ml Eppendorf tubes and microtiter plates, such as for example 20 μl microtiter plates (per cavity). The reagent vessel 36 may in particular be/comprise a turret drum/drum. However, it is pointed out that the way in which the reagent vessel 36 can be formed is not limited to the examples enumerated here. Furthermore, the dimensions of the reagent vessel 36 are only governed by the desired usability of the reagent vessel 36 in the centrifuge and/or in the pressure varying device. However, the way in which the technology according to the disclosure described hereinafter can be embodied does not prescribe any external form of the reagent vessel 36. Therefore, the reagent vessel 36 may be configured for receiving samples in an amount that can be chosen optionally from a range of a few μl to 1 μl.

It is pointed out that the centrifuge and pressure varying device mentioned hereinafter should not be understood as meaning any specific types of device. Instead, the technology according to the disclosure can be used by means of any centrifuge by means of which a (minimum) centrifugal force of 20 g can be exerted. Similarly, the technology according to the disclosure can be used for any pressure varying device by means of which a negative and/or positive pressure can be applied.

The reagent vessel insert 10 may be understood as meaning for example a turret component/turret. Similarly, the reagent vessel insert 10 may comprise a turret. The reagent vessel part may in particular be a turret drum/drum. However, other embodiments of a reagent vessel insert 10 that can be arranged in a reagent vessel 36 for a centrifuge and/or a pressure device are similarly possible. The reagent vessel insert 10 has an insert housing 10a, which can be arranged/inserted in at least one reagent vessel 36. The respective reagent vessel 36 may be formed as one of the embodiments enumerated above, without being limited to them. The insertability of the insert housing 10a into the reagent vessel 36 concerned for a centrifuge and/or a pressure varying device can be interpreted as meaning that an outer wall 10b of the insert housing 10a corresponds at least partially to an inner wall 36b of the reagent vessel 36, or of a reagent vessel part. Preferably, a reliable hold/fit of the reagent vessel insert 10 in the reagent vessel 36 concerned, or the reagent vessel part, is also ensured during operation of the centrifuge and/or the pressure varying device.

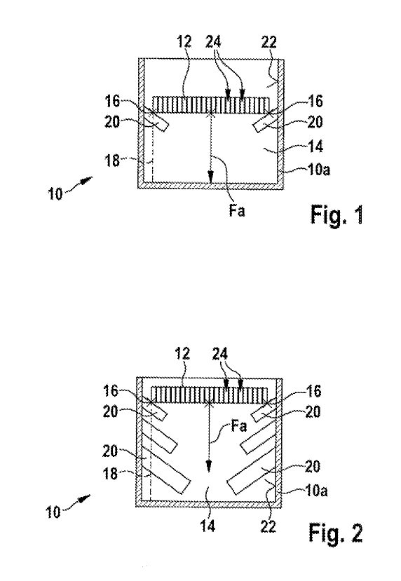

FIG. 1 shows a schematic partial representation of a first embodiment of the reagent vessel insert.

The reagent vessel insert 10 that is schematically represented (at least partially) in FIG. 1 comprises at least one agitating element 12, which is arranged in an interior volume 14 that is formed in the insert housing 10a such that a place and/or a position of the at least one agitating element 12 with respect to the insert housing 10a can be changed. At least one subunit 16 of the at least one agitating element 12 can be adjusted along an adjusting path 18 such that at least one material that can be filled or has been filled (not depicted) into the at least one interior volume 14 can be agitated. During an adjustment along the adjusting path 18, the at least one subunit 16 of the at least one agitating element 12 contacts at least one holding structure 20, by means of which the at least one agitating element 12 can be held in at least one semi-stable place and/or in at least one semi-stable position with respect to the insert housing 10a.

By means of the dwelling of the at least one agitating element 12 in the at least one semi-stable place and/or in the at least one semi-stable position, the energy exerted on the at least one agitating element 12 to overcome the at least one holding structure 20 can be introduced as kinetic energy into the at least one material to be mixed. In this way, a flow rate brought about in the at least one material to be mixed can be increased, which on account of the internal friction thereof brings about more chaotic flows. Consequently, the mixing efficiency when mixing the at least one material can be improved by means of the at least one holding structure 16.

The at least one semi-stable place and/or the at least one semi-stable position may be understood as meaning a place/position of the at least one agitating element 12 from which the at least one agitating element 12 can be adjusted into at least one further place/position with a reduced potential energy, an energy threshold having to be overcome to adjust the at least one agitating element 12 from the semi-stable place/position. For example, the at least one agitating element 12 in the semi-stable place/position has a first potential energy, which is greater than a second potential energy of the at least one agitating element 12 in the further place/position, the adjustment of the at least one agitating element 12 from the semi-stable place/position into the further place/position only being possible by way of an intermediate place of the at least one agitating element 12 with a third potential energy that is greater than the first potential energy. The energy threshold may also be predetermined by a deformation of the at least one agitating element 12 and/or the at least one holding structure 20 that has to be performed to adjust the at least one agitating element 12 from the semi-stable place/position into the further place/position.

The at least one holding structure 20 may protrude from at least one inner wall 22 of the at least one interior volume 14. Consequently, a comparatively simple form of the at least one holding structure 20 can already bring about the significant advantage described above. In the case of the embodiment of FIG. 1, the at least one holding structure 20 is at least partially made of an elastic material. As specified more precisely below, the at least one holding structure 20 can consequently be used repeatedly without any damage to it having to be feared. However, the way in which the at least one holding structure 20 is formed is not restricted to the use of an elastic material.

The at least one agitating element 12 may be adjustable for example by means of an actuator force Fa which can be brought about as a centrifugal force in the case of operation of the centrifuge, in which the reagent vessel is inserted with the reagent vessel insert 10 arranged therein, and/or as a compressive force in the case of operation of the pressure varying device, in which the reagent vessel containing the reagent vessel insert 10 is inserted. Consequently, forces that can be easily initiated are used for adjusting the at least one agitating element 12 when mixing the at least one material.

The at least one agitating element 12 can preferably be held in the at least one semi-stable place and/or the at least one semi-stable position until the actuator force Fa which can be brought about exceeds a threshold value fixed by means of the form of the at least one contacted holding structure 20. When the threshold value is exceeded by the actuator force Fa which can be brought about, at least the at least one subunit 16 of the at least one agitating element 12 can be adjusted further along at least one subsection of the adjusting path 18. In a preferred way, when the threshold value is exceeded by means of the actuator force Fa which can be brought, the at least one agitating element 12 can be thrown out from the at least one semi-stable place and/or from the at least one semi-stable position. Consequently, a comparatively great kinetic energy can be transferred to the at least one material to be mixed. The operation of throwing out the at least one agitating element 12 from the at least one semi-stable place and/or from the at least one semi-stable position can also be described as an overcoming/breaking through of the at least one contacted holding structure 20.

The limit value/threshold value for the rotational acceleration/rotational speed of the centrifuge from which the actuator force Fa brought about as a centrifugal force is sufficient for overcoming/breaking through the at least one contacted holding structure 20 may be at least 20 g, for example at least 100 g, preferably at least 500 g, in particular at least 1000 g. Correspondingly, the compressive force from which the at least one holding structure 20 is overcome/broken through may only be obtained when there is a significant negative or positive pressure.

Preferably, the at least one agitating element 12 has at least one passing-through opening 24/pore. The flows that are brought about when the at least one material to be mixed flows through the at least one passing-through opening/pore can consequently additionally increase the mixing efficiently. The at least one passing-through opening 24/pore may be of any form desired, for example rectangular or circular. A diameter of the at least one passing-through opening 24/pore may in particular lie in a range between 0.1 and 3 mm. However, the range mentioned here for the diameter of the at least one passing-through opening 24/pore should only be interpreted as given by way of example.

In the case of the embodiment of FIG. 1, the agitating element 12 represented is configured as a screen. Instead of or as an alternative to screen structures, the at least one agitating element 12 may also have rake structures, finger structures and/or grid structures. In all of the cases enumerated, the mixing efficiency can be increased on the basis of the multiplicity of passing-through openings 24/pores.

In the case of the embodiment of FIG. 1, the agitating element 12 is unattached, i.e. formed without any connection to a wall of the interior volume 14. As explained more precisely below, however, an alternative to the unattached agitating element 12 represented in FIG. 1 is also possible.

FIG. 2 shows a schematic partial representation of a second embodiment of the reagent vessel insert.

The reagent vessel insert 10 schematically reproduced (at least partially) in FIG. 2 is a development of the previously described embodiment. The holding structures 20 arranged in the interior volume 14 can be divided into a number of groups, which are contacted one after the other during the adjusting movement of the agitating element 12. The obstacle structure realized in this way, comprising a number of groups of holding structures 20, allows a sequential adjustment of the agitating element 12 in the interior volume 14 acting as a mixing chamber by means of the actuator force Fa, and consequently repeated effective introduction of energy into the at least one material to be mixed.

The various groups of holding structures 20 may have the same threshold value or different threshold values. The different threshold values can be fixed for example by means of a different elasticity of the various groups of holding structures 20. In both cases, a jerky and multiple movement of the agitating element 12 can be realized.

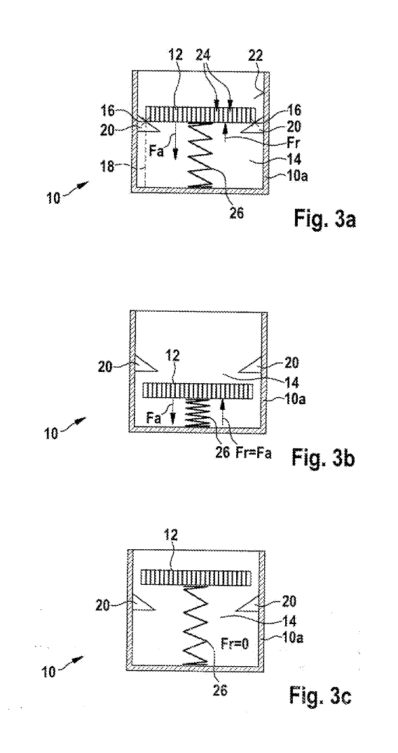

FIGS. 3a-3c show schematic partial representations of a third embodiment of the reagent vessel insert.

The reagent vessel insert 10 respectively reproduced (at least partially) in FIGS. 3a-3c is also a development/modification of the embodiment described at the beginning. In the case of the reagent vessel insert 10 of FIGS. 3a-3c, at least one elastic restoring element 26 is arranged on the at least one agitating element 12 such that at least the at least one subunit 16 of the at least one agitating element 12 can be adjusted from a starting position (see FIG. 3c) into a maximum deflecting position (see FIG. 3b) by means of the actuator force Fa which can be brought about that is greater than a restoring force Fr of the respective at least one restoring element 26. Furthermore, at least the at least one subunit 16 of the at least one agitating element 12 can be adjusted back into the starting position when there is an actuator force Fa which can be brought about that is less than the restoring force Fr. In particular, when the at least one subunit 16 of the at least one agitating element 12 is adjusted from the starting position, the restoring force Fr of the respective at least one restoring element 26 is increased. In this case, the at least one subunit 16 of the at least one agitating element 12 can contact at least one holding structure 20 in its starting position and/or during the adjustment from the starting position into the maximum deflecting position, and overcome/break through the at least one holding structure 20 when there is an actuator force Fa greater than the sum of the applied restoring force Fr and the threshold value.

This can also be described by saying that, when the assigned agitating element 12 is adjusted out of its starting place/starting position, the at least one restoring element 26 is tensioned or compressed such that the restoring force Fr increases. However, in spite of the increase in the restoring force Fr, the respective agitating element 12 can be adjusted further by means of a greater actuator force Fa. If the actuator force Fa is greater than a sum of the applied restoring force Fr and the at least one threshold value of the at least one holding structure 20 contacted by the agitating element 12, the respective agitating element 12 can be adjusted into a maximum deflecting place/deflecting position. Preferably, the agitating element 12 can be adjusted from the maximum deflecting place/deflecting position back into its starting place/starting position as from an actuator force Fa that is less than the applied restoring force Fr. In a preferred way, during the adjustment from the maximum deflecting place/deflecting position into its starting place/starting position, the agitating element 12 contacts the at least one holding structure 20 once again. After that, the advantageous transfer of kinetic energy to the at least one material to be mixed can be repeated at least once by means of simple variation of the actuator force Fa. The embodiment of FIGS. 3a-3c can therefore be described as a reversible snap mechanism.

The at least one holding structure 20 may be of a rigid or elastic (flexible) configuration. The at least one restoring element 26 may for example be a spring. As an alternative or in addition to this, the at least one restoring element 26 may also be formed from a compressible or extensible material, such as for example a polymer and/or an elastomer. The restoring force Fr may be both a compressive force and a tensile force. In particular, a number of restoring elements 26 can advantageously act together.

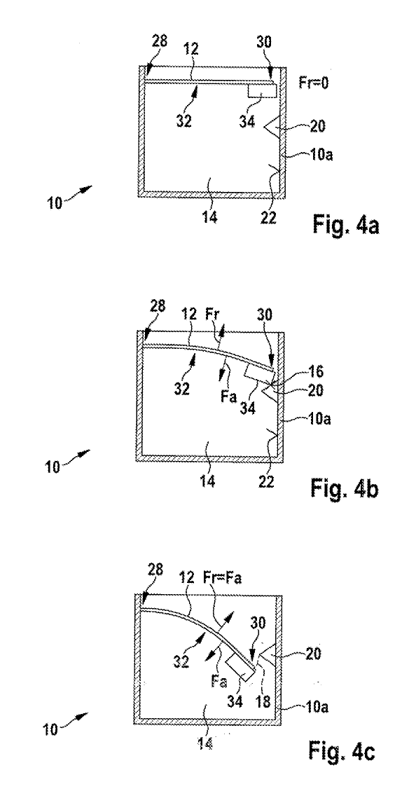

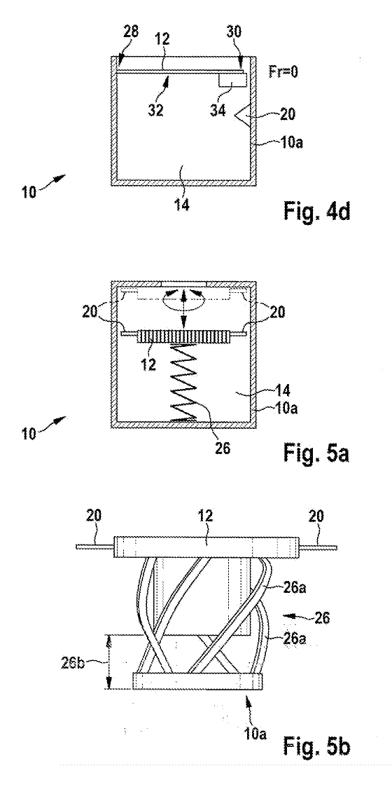

FIGS. 4a-4d show schematic partial representations of a fourth embodiment of the reagent vessel insert.

The reagent vessel insert 10 partially represented in FIGS. 4a-4d has at least one agitating element 12, which is fixedly attached at its first end 28 to the reagent vessel insert 10, or a component that is fixedly fastened in the reagent vessel insert 10. In a preferred way, the first end 28 is fastened in the reagent vessel insert 10 to such a fixed extent that it does not change its position with respect to the insert housing 10a even under an acceleration exerted on it of 10 000 g, or a corresponding compressive force. A second end 30 of the respective agitating element 12 is adjustable with respect to the first end 28 of the same agitating element 12 from a starting position by bending of at least one intermediate subsection 32 of the same agitating element 12. Preferably, the at least one intermediate subsection 32 is formed such that the bending thereof brings about a restoring force Fr by means of which the second end 30 can be adjusted back into the starting position with respect to the first end 28.

The at least one agitating element 12 may be formed as a bar or web. For example, the agitating element 12 formed as a bar or web may have a width of between 0.1 and 3 mm. In particular, a number of agitating elements 12 formed as bars or webs and arranged in relation to one another with a spacing of between 0.1 and 3 mm may be used. Similarly, the at least one agitating element 12 may be formed as a comb (with lateral webs). The numerical values and possible formulas of the at least one agitating element 12 that are mentioned here should, however, only be interpreted as given by way of example.

Preferably, an additional mass 34 is arranged at the at least one second end 30 of the at least one agitating element 12. Since the kinetic energy transferred to the at least one material to be mixed is proportional to the accelerated mass, the mixing efficiency can consequently be increased by means of the additional mass 34.

In FIG. 4a, the agitating element 12 is in its starting place. The restoring force Fr is consequently equal to zero. By means of an actuator force Fa, the agitating element 12 can be adjusted from its starting place into at least one stop place, in which the agitating element 12 contacts at least one holding structure 20. By means of the at least one contacted holding structure 20, the agitating element 12 can be held in a semi-stable place until the actuator force Fa exerted on it is greater than a sum of a threshold value, fixed by the at least one contacted holding structure 20, and the at least one restoring force Fr. If the actuator force Fa exceeds this sum, the agitating element 12 can bend elastically such that it snaps out from the semi-stable place and in this way introduces a high level of kinetic energy into the at least one material to be mixed.

Once the at least one holding structure 20 has been overcome/broken through, the at least one agitating element 12 can continue to be bent until it is in a maximum deflecting position, in which the restoring force Fr of the bent intermediate subsection 32 is equal to the actuator force Fa (see FIG. 4c). By reducing the actuator force Fa to below the applied restoring force Fr, the at least one agitating element 12 can be adjusted back into its starting place once again (see FIG. 4d). By means of increasing the actuator force Fa once again, the operations presented on the basis of FIGS. 4a-4d can be repeated at least once. The embodiment of FIGS. 4a-4d consequently realizes a reversible/repeatedly usable snap mechanism.

As an alternative or in addition to the holding structures 20 described above, the at least one holding structure 20 may also be formed as an arrestment with a predetermined breaking point, or as a predetermined breaking point.

FIGS. 5a and 5b show schematic partial representations of a fifth embodiment of the reagent vessel insert.

In the case of the embodiment of FIGS. 5a and 5b, on account of the at least one holding structure 20, the at least one agitating element 23 is fixedly arranged in the interior volume before the reagent vessel insert 10 equipped with it is put to use. Only once the threshold value fixed by the at least one holding structure 20 formed as a predetermined breaking point is exceeded by means of the actuator force Fa is the at least one agitating element 12 at least partially made to break free such that it can perform the mixing operation to use the energy thereby released.

On the basis of this described functional principle, an agitating element 12 may additionally also be used as a mechanical one-way bursting valve. For example, the agitating element 12 may close a channel or reservoir until the agitating element 12 is made to break free when there is a greater actuator force Fa, and at the same time begins performing the mixing operation.

In a further embodiment, the agitating element 12 snapping out from the at least one semi-stable position and/or semi-stable place may also break open a predetermined breaking point, and thereby expose a reservoir and/or open an outflow. In an advantageous way, in this case the agitating element 12 may also be equipped with a point, a cutting edge and/or a spike, by means of which a separating structure/membrane can be pierced.

The agitating element 12 represented in FIGS. 5a and 5b is formed in one piece with at least one restoring element 26 formed as a spring. The restoring element 26 may be formed for example as a helical spring. Similarly, the restoring element 26 may be formed as a multistrand spring (see FIG. 5b). This may be understood as meaning that the restoring element 26 has a number of spring strands 26a, which are anchored on the agitating element 12 and wrap around at least part of the agitating element 12. Such a type of spring is adjustable by a comparatively great differential travel 26b without any tilting of the agitating element 12. However, it is pointed out that the agitating element 12 formed in one piece with the at least one restoring element 26 is not limited to a specific type of spring.

As an alternative to the embodiment of FIGS. 5a and 5b, the agitating element 12 may also be formed in one piece with at least one elastic supporting component and/or with at least one compressible supporting component. The at least one elastic supporting component and/or compressible supporting component may comprise a polymer and/or an elastomer.

In the reagent vessel inserts 10 described above, still further process steps and structures may be integrated, such as for example sedimentation structures, channel structures or siphon structures for passing on and switching at least one liquid contained in the reagent vessel inserts 10. In particular, at least one subunit of the interior volume 14 or of some other volume of a reagent vessel insert 10 may be filled as a “storage vessel” with at least one liquid, which undergoes at least one chemical reaction and/or a biochemical/electrobiological process with a subsequently filled-in material/sample material to be processed and/or to be investigated. The at least one “storage vessel” may for example be filled with chemicals, dyes, antibodies, antigens, receptors, proteins, DNA strands and/or RNA strands.

The reagent vessel inserts 10 described above may be made at least partially from a polymer, for example from COP, COC, PC, PA, PU, PP, PET and/or PMMA. Further materials are also suitable for forming the reagent vessel inserts 10. These may be firm, elastic or flexible. Suitable materials are also for example metal, polymer, paper, plastic, rubber material, or the like. For dividing the reagent vessel inserts 10 into a number of (closed) liquid volumes, special chambers, containers and/or doors may be formed.

The reagent vessel inserts 10 may also be equipped with additional components, such as for example valves and/or pumps. Furthermore, the technology according to the disclosure may act together in a simple way with a multiplicity of conventional actuation, detection and/or control units. The embodiments described above may also have additional mechanical switches and/or actuating mechanisms, such as for example magnetic, electrical or electromagnetic anti or rejecting mechanisms.

By means of the reagent vessel inserts 10, chemical and biochemical processes can be performed in a fully automated manner. It is pointed out that the figures described can be interpreted as simplifications of the reagent vessel inserts 10 that can be realized.

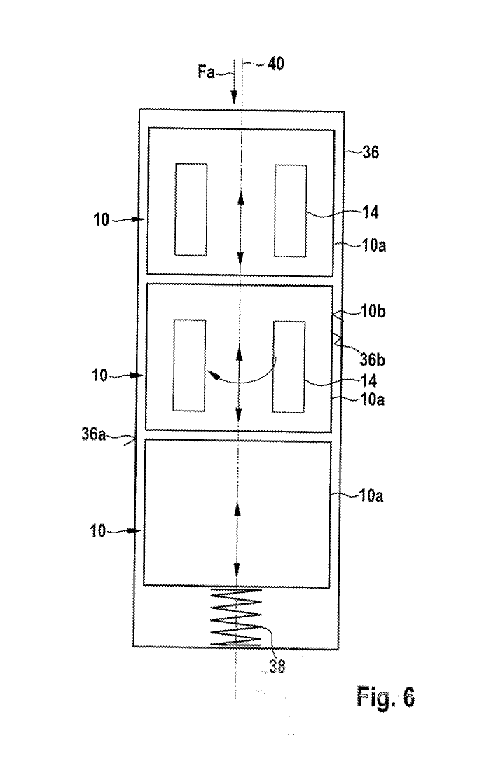

FIG. 6 shows a schematic representation of an embodiment of the reagent vessel.

The reagent vessel 36 schematically represented in FIG. 6 has a number of reagent vessel inserts 10 formed as turret components/turrets. The various turret components 10 are arranged axially one on top of the other. By means of an integrated mechanism, such as for example a ballpoint pen mechanism 38 and/or a ratchet mechanism, the turret components 10 can be rotated and/or axially adjusted with respect to their position in relation to one another, the interior volumes 14 and/or further cavities of the turret components 10 allowing themselves to be switched in relation to one another. (The turret components 10 may also have in addition to the components of equipment described above, channels, reaction chambers and further structures for the carrying out of fluidic unit operations.)

Activation of the mechanism used may take place for example by means of the actuator force Fa. By means of the activated mechanism, the turret components 10 may allow themselves to be switched in relation to one another such that their openings coincide, and consequently liquids can be transported along a vector 40 of the actuator force Fa from at least one turret component 10 into a neighboring turret component 10.

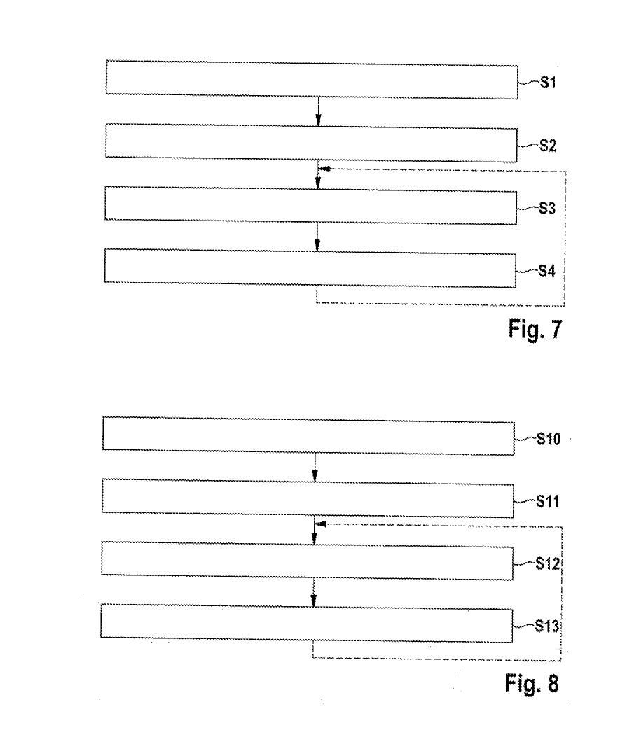

FIG. 7 shows a flow diagram for presenting an embodiment of the method for the centrifuging of at least one material.

The method reproduced in FIG. 7 may be performed for example by using the embodiments described above. However, the ability to perform the method is not reduced to the use of these.

In a method step S1, the at least one material is filled into a reagent vessel for a centrifuge with an inserted advantageous reagent vessel insert or in a corresponding reagent vessel. The reagent vessel is arranged in the centrifuge in a method step S2.

In a method step S3, the centrifuge is operated for at least a first time interval at a first rotational speed. The first rotational speed brings about a centrifugal force below a threshold value fixed by the at least one holding structure contacted by the at least one agitating element. Therefore, the at least one agitating element is held in the respective semi-stable place and/or in the respective semi-stable position by means of the at least one holding structure.

In a subsequent method step S4, the rotational speed is increased for at least a second time interval to a second rotational speed. The second rotational speed brings about a centrifugal force above the threshold value, whereby the at least one agitating element is thrown out from the respective semi-stable place and/or from the respective semi-stable position. This ensures advantageous mixing of the at least one material.

The method steps S3 and S4 can be repeated as often as desired, in order to increase the mixing efficiency.

FIG. 8 shows a flow diagram for explaining an embodiment of the method for the pressure treatment of at least one material.

The devices described above can also be used for performing the method described hereinafter. However, the ability to perform the method described hereinafter is not limited to the use of these devices.

The method begins with a method step S10, in which the at least one material is filled into a reagent vessel for a pressure varying device with an inserted advantageous reagent vessel insert or into a corresponding reagent vessel. Arranging the reagent vessel in the pressure varying device takes place in a method step S11.

After that, in a method step S12, a first pressure difference, deviating from atmospheric pressure and with the effect of bringing about a compressive force below a threshold value fixed by the at least one holding structure contacted by the at least one agitating element, is created in the reagent vessel by means of the pressure varying device for at least a first time interval. Consequently, the at least one agitating element is held in the respective semi-stable place and/or in the respective semi-stable position by means of the at least one holding structure.

In a further method step S13, a second pressure difference, deviating from atmospheric pressure and greater than the first pressure difference, is created for at least a second time interval. As a result, a compressive force above the threshold value is brought about, whereby the at least one agitating element is thrown out from the respective semi-stable place and/or from the respective semi-stable position. The at least one material is consequently mixed.

Method steps S3 and S4 may also be repeated as often as desired to increase the mixing efficiency.

What is claimed is:

1. A reagent vessel insert for a reagent vessel for a centrifuge and/or a pressure varying device, the reagent vessel insert comprising:
an insert housing formed to enable insertion of the reagent vessel insert in a reagent vessel for a centrifuge and/or a pressure varying device;
at least one agitating element arranged in at least one interior volume formed in the insert housing such that a place and/or a position of the at least one agitating element is changeable with respect to the insert housing; and
at least one holding structure configured to hold the at least one agitating element in at least one semi-stable place and/or at least one semi-stable position with respect to the insert housing,
wherein at least one subunit of the at least one agitating element is configured to be adjusted along an adjusting path to enable agitation of at least one material filled into the at least one interior volume, and
wherein, during adjustment along the adjusting path, at least the at least one subunit of the at least one agitating element contacts the at least one holding structure.

2. The reagent vessel insert according to claim 1, wherein the at least one agitating element is configured to be adjusted by a centrifugal force brought about during operation of the centrifuge in which the reagent vessel is inserted and/or a compressive force brought about during operation of the pressure varying device in which the reagent vessel is inserted.

3. The reagent vessel insert according to claim 2, wherein:
the at least one agitating element is configured to be held in the at least one semi-stable place and/or the at least one semi-stable position until the centrifugal force and/or the compressive force exceeds a threshold value fixed by a form of the at least one contacted holding structure, and
when the threshold value is exceeded by the centrifugal force and/or the compressive force, at least the at least one subunit of the at least one agitating element is adjusted further along at least one subsection of the adjusting path.

4. The reagent vessel insert according to claim 3, wherein, when the threshold value is exceeded by the centrifugal force and/or by the compressive force, the at least one agitating element is thrown out from the at least one semi-stable place and/or from the at least one semi-stable position.

5. The reagent vessel insert according to claim 2, further comprising:
at least one elastic restoring element arranged on the at least one agitating element to enable adjustment of at least the at least one subunit of the at least one agitating element from a starting position into a maximum deflecting position by a centrifugal force and/or a compressive force that is greater than a restoring force of the respective at least one restoring element, the at least one elastic restoring element further arranged to enable adjustment of at least the at least one subunit of the at least one agitating element back into the starting position when there is a centrifugal force and/or a compressive force that is less that the restoring force.

6. The reagent vessel insert according to claim 1, wherein the at least one holding structure is configured to protrude from at least one inner wall of the at least one interior volume.

7. The reagent vessel insert according to claim 1, wherein the at least one holding structure is at least partially formed from an elastic material.

8. The reagent vessel insert according to claim 1, wherein the at least one agitating element includes at least one of rake structures, screen structures, finger structures, and grid structures.

9. The reagent vessel insert according to claim 1, wherein:
the at least one agitating element has a first end and a second end,
the first end of the at least one agitating element is fixedly attached to the reagent vessel insert while the second end of the at least one agitating element is configured to be adjusted with respect to the first end of the at least one agitating element by bending at least one intermediate subsection of the at least one agitating element.

10. The reagent vessel insert according to claim 9, further comprising an additional mass attached to the second end of the at least one agitating element.

11. The reagent vessel insert according to claim 1, wherein the reagent vessel insert is formed as a turret component.

12. A reagent vessel for a centrifuge and/or a pressure varying device, the reagent vessel including at least one reagent vessel insert according to claim 1.

13. A reagent vessel for a centrifuge and/or a pressure varying device, the reagent vessel comprising:
an outer wall formed to enable the reagent vessel to be inserted in a centrifuge and/or in a pressure varying device; and
at least one agitating element arranged in at least one interior volume formed in the reagent vessel such that a place and/or a position of the at least one agitating element is changeable with respect to the outer wall; and
at least one holding structure configured to hold the at least one agitating element in at least one semi-stable place and/or at least one semi-stable position with respect to the outer wall,
wherein at least one subunit of the at least one agitating element is configured to be adjusted along an adjusting path such that at least one material filled into the at least one interior volume is agitatable;
wherein, during an adjustment along the adjusting path, at least the at least one subunit of the at least one agitating element contacts at least one holding structure.

14. A method for the centrifuging of at least one material, comprising:
filling the at least one material into one of:
a reagent vessel for a centrifuge with an inserted reagent vessel insert, the reagent vessel insert including an insert housing formed to enable insertion of the reagent vessel insert in a reagent vessel for a centrifuge and/or a pressure varying device, the reagent vessel insert further including at least one agitating element arranged in at least one interior volume formed in the insert housing such that a place and/or a position of the at least one agitating element is changeable with respect to the insert housing, and the reagent vessel insert further including at least one holding structure configured to hold the at least one agitating element in at least one semi-stable place and/or at least one semi-stable position with respect to the insert housing, wherein at least one subunit of the at least one agitating element is configured to be adjusted along an adjusting path to enable agitation of at least one material filled into the at least one interior volume, and wherein, during adjustment along the adjusting path, at least the at least one subunit of the at least one agitating element contacts the at least one holding structure, and
a reagent vessel including at least one reagent vessel insert;
arranging the reagent vessel in the centrifuge;
for at least a first time interval, operating the centrifuge at a first rotational speed to bring about a centrifugal force below a threshold value fixed by the at least one holding structure contacted by the at least one agitating element to hold the at least one agitating element in the respective semi-stable place and/or in the respective semi-stable position by the at least one holding structure; and
for at least a second time interval, increasing a rotational speed of the centrifuge to a second rotational speed to bring about a centrifugal force above the threshold value to throw out the at least one agitating element from the respective semi-stable place and/or from the respective semi-stable position to mix the at least one material.

15. A method for the pressure treatment of at least one material, comprising:
filling the at least one material into one of:
a reagent vessel for a pressure varying device with an inserted reagent vessel insert the reagent vessel insert including an insert housing formed to enable insertion of the reagent vessel insert in a reagent vessel for a centrifuge and/or a pressure varying device, the reagent vessel insert further including at least one agitating element arranged in at least one interior volume formed in the insert housing such that a place and/or a position of the at least one agitating element is changeable with respect to the insert housing, and the reagent vessel insert further including at least one holding structure configured to hold the at least one agitating element in at least one semi-stable place and/or at least one semi-stable position with respect to the insert housing, wherein at least one subunit of the at least one agitating element is configured to be adjusted along an adjusting path to enable agitation of at least one material filled into the at least one interior volume, and wherein, during adjustment along the adjusting path, at least the at least one subunit of the at least one agitating element contacts the at least one holding structure, and
a reagent vessel including at least one reagent vessel insert;
arranging the reagent vessel in the pressure varying device;
for at least a first time interval, creating a first pressure difference, deviating from atmospheric pressure, to bring about a compressive force below a threshold value fixed by the at least one holding structure contacted by the at least one agitating element, in the reagent vessel by the pressure varying device to hold the at least one agitating element in the respective semi-stable place and/or in the respective semi-stable position by the at least one holding structure; and
for at least a second time interval, creating a second pressure difference, deviating from atmospheric pressure and greater than the first pressure difference, to bring about a compressive force above the threshold value to throw out the at least one agitating element from the respective semi-stable place and/or from the respective semi-stable position to mix the at least one material.
